(19) United States
(12) Patent Application Publication
(10) Pub. No.: US 2018/0325100 A1
(43) Pub. Date: Nov. 15, 2018

(54) Cryopreservative Compositions And Methods Of Use Thereof

(71) Applicant: Akron Biotechnology, LLC., Boca Raton, FL (US)

(72) Inventors: Claudia Zylberberg, Delray Beach, FL (US); Sandro Matosevic, Lake Worth, FL (US)

(21) Appl. No.: 15/776,636

(22) PCT Filed: Nov. 15, 2016
(86) PCT No.: PCT/US2016/062064

§ 371 Date: May 16, 2018

Related U.S. Application Data
(60) Provisional application No. 62/255,813, filed on Nov. 16, 2015.

(51) Int. Cl. A01N 1/02

(52) U.S. Cl. CPC A01N 1/0221

(57) ABSTRACT

Cryopreservative compositions include a carboxylated-polyamino acid, and at least one of an organic amphoteric agent or a polysaccharide. Methods of cryopreservation are also provided.

### TECHNICAL FIELD

The present disclosure relates to compositions suitable for cryopreservation of biological samples, and particularly, cryopreservative compositions which include a carboxylatedpolyamino acid, and at least one of an organic amphoteric agent or a polysaccharide. Methods of use of the cryopreservative compositions are also described herein.

### BACKGROUND

Cryopreservation is a process where biological samples such as cells or whole tissues are preserved by cooling to low, sub-zero temperatures. At such low temperatures, any biological activity, including the biochemical reactions that would normally lead to cell death, is effectively stopped. Cryopreservation has many different research and clinical applications. By way of example, there is a frequent research need to store cell or tissue samples for a period of time in a manner so as to preserve their potential for resuming biological activity, such as in the cases of cell culture samples and hybridomas. In addition, there is a frequent clinical need to preserve and to store cells while preserving their potential biological activity, such as in the case of autologous bone marrow transplants, cord blood storage, and the storage of human gametes.

However, traditional cryopreservation techniques can be hampered by the formation of ice crystals and the increase in ionic strength of unfrozen concentrated solutions, both of which can cause damage to the biological sample. One technique for maintaining the biological activity of cell samples in the context of cryopreservation is the use of dimethyl sulfoxide (DMSO) as a cryoprotective agent that functions to increase the number of cells that survive both the cooling process and the subsequent heating process. DMSO is generally used at a final concentration of 5% to 15% v/v (volume per volume) (0.74 to 2.5 molal). DMSO is believed to work at least in part by disrupting the process of ice crystal formation, thereby reducing the physical disruption of cell membranes. However, DMSO is toxic and can also cause various side effects. For example, patients who receive autologous cell transplants that have been preserved in DMSO can experience side effects including headaches, nausea and skin rash. (Davis, J M et. al., Blood, 75(3), 1990, pp 781-786). In addition, some cell lines are adversely affected by prolonged contact with DMSO.

Another technique for maintaining the biological activity of cell samples in the context of cryopreservation is the use of glycerol as a cryoprotective agent. Glycerol is generally used at a final concentration of between 5 and 20% v/v. Although glycerol is generally less toxic to cells than DMSO, glycerol can cause osmotic problems, especially after thawing, which can affect cell viability.

Yet another technique for maintaining biological activity of cell samples in the context of cryopreservation is the use of polyethylene glycol (PEG). However, most studies show that PEG is most efficient when combined with DMSO and thus does not eliminate the undesirable characteristics associated with DMSO. Moreover, PEG undergoes sonolytic degradation, the by-products of which are toxic to mammalian cells. Thus, there is a need in the art for the protection of cells and tissues during freezing and thawing cycles associated with cryopreservation.

### SUMMARY

The present disclosure provides cryopreservative compositions which include a carboxylated polyamino acid, and at least one of an organic amphoteric agent or a polysaccharide. In embodiments, the carboxylated polyamino acid is carboxylated-polylysine. In embodiments, the organic amphoteric agent is selected from ectoine and/or hydroxyectoine. In embodiments, the polysaccharide is dextran.

In embodiments, cryopreservative compositions in accordance with the present disclosure are useful for slow-rate cryopreservation and include from about 0.1% to about 20% v/v (volume per volume) of a carboxylated polyamino acid and from about 0.1% to about 20% w/v (weight per volume) of an organic amphoteric agent. In embodiments, the cryopreservative compositions for slow-rate cryopreservation include from about 0.1% to about 20% v/v of a carboxylated polyamino and from about 0.1% to about 20% w/v of a polysaccharide. In embodiments, the cryopreservative compositions for slow-rate cryopreservation include from about 0.1% to about 20% v/v of a carboxylated polyamino acid, from about 0.1% to about 20% w/v of an organic amphoteric agent, and from about 0.1% to about 20% w/v of a polysaccharide. In embodiments, the presently described cryopreservative compositions for slow-rate cryopreservation include from about 1% to about 10% v/v of a carboxylated polyamino acid and from about 1% to about 10% w/v of an organic amphoteric agent. In embodiments, the cryopreservative compositions for slow-rate cryopreservation include from about 0.1% to about 10% v/v of a carboxylated polyamino and from about 1% to about 10% w/v of a polysaccharide. In embodiments, the cryopreservative compositions for slow-rate cryopreservation include from about 0.1% to about 10% v/v of a carboxylated polyamino acid, from about 0.1% to about 10% w/v of an organic amphoteric agent, and from about 0.1% to about 10% w/v of a polysaccharide. In embodiments, the cryopreservative compositions for slow-rate cryopreservation include a carboxylated polyamino acid in a ratio to an organic amphoteric agent of about 1.1:1 to about 3:1, in embodiments from about 1.3:1 to about 1.7:1, in embodiments about 1.5:1. In embodiments, the cryopreservative compositions for slow-rate cryopreservation include a carboxylated polyamino acid in a ratio to an organic amphoteric agent and a polysaccharide of about 1.1:1:1 to about 3:1:1, in embodiments from about 1.3:1:1 to about 1.7:1:1, in embodiments about 1.5:1:1.

In embodiments, the cryopreservative compositions for slow-rate cryopreservation include about 7.5% or less v/v of a carboxylated polyamino acid, from about 5% or less w/v of an organic amphoteric agent, and about 5% or less w/v of a polysaccharide. In embodiments, the cryopreservative compositions for slow-rate cryopreservation include about 7.5% or less v/v of a carboxylated polylysine, about 5% or less w/v of ectoine and/or hydroxyectoine, and about 5% or less w/v of dextran.

A method of storing a biological sample in a viable condition is also described which includes adding a cryopreservative composition to a biological sample, and performing slow-rate cryopreservation on the biological sample, wherein the cryopreservative composition includes a carboxylated-polylysine, and at least one of an organic amphoteric agent or a polysaccharide. In embodiments, the cryopreservative composition includes from about 1% to about 10% v/v of a carboxylated-polylysine having greater than 50% of amino groups blocked, from about 1% to about 10% w/v ectoine, and from about 0% to about 10% w/v of dextran.

In embodiments, cryopreservative compositions in accordance with the present disclosure are useful for fast-rate cryopreservation and include from about 25% to about 55% v/v of a carboxylated polyamino acid, from about 25% to about 55% w/v of an organic amphoteric agent, and optionally from about 25% to about 55% w/v of a polysaccharide. In embodiments, the carboxylated polyamino acid is carboxylated-polylysine. In embodiments, the organic amphoteric agent is selected from ectoine and/or hydroxyectoine. In embodiments, the cryopreservative compositions for fast-rate cryopreservation do not include a polysaccharide. In embodiments, the cryopreservative compositions for fast-rate cryopreservation include a polysaccharide. In embodiments, the polysaccharide is dextran.

In embodiments, the cryopreservative compositions for fast-rate cryopreservation include from about 30% to about 52.5% v/v of a carboxylated polyamino acid, from about 25% to about 35% w/v of an organic amphoteric agent, and optionally from about 25% to about 35% w/v of a polysaccharide. In embodiments, the cryopreservative compositions for fast-rate cryopreservation include a carboxylated polyamino acid in a ratio to an organic amphoteric agent of about 1.1:1 to about 3:1, in embodiments from about 1.3:1 to about 1.7:1, in embodiments about 1.5:1. In embodiments, the cryopreservative compositions for fast-rate cryopreservation include a carboxylated polyamino acid in a ratio to an organic amphoteric agent and a polysaccharide of about 1.1:1:1 to about 3:1:1, in embodiments from about 1.3:1:1 to about 1.7:1:1, in embodiments about 1.5:1:1.

A method of storing a biological sample in a viable condition is also described which includes adding a cryopreservative composition to a biological sample, and performing fast-rate cryopreservation on the biological sample, wherein the cryopreservative composition includes a carboxylated-polylysine, and at least one of an organic amphoteric agent or a polysaccharide. In embodiments, the cryopreservative composition includes from about 25% to about 55% v/v of a carboxylated-polylysine having greater than 50% of amino groups blocked, from about 25% to about 35% w/v ectoine, and optionally from about 25% to about 35% w/v of dextran.

### BRIEF DESCRIPTION OF THE DRAWINGS

FIG. 1 is a bar graph illustrating cell recovery of TIG-3-20 Fibroblasts in cryopreservative compositions of at least one embodiment described herein.

FIG. 2 is a bar graph illustrating cell viability of TIG-3-20 Fibroblasts in cryopreservative compositions of at least one embodiment described herein.

FIG. 3 is a bar graph illustrating cell viability via CalceinAM of dendritic cells in cryopreservative compositions of at least one embodiment described herein.

FIG. 4 is a bar graph illustrating cell recovery of Natural Killer 92 (NK-92) cells in cryopreservative compositions of at least one embodiment described herein.

FIGS. 5a and 5b are bar graphs illustrating cell viability of NK-92 cells in cryopreservative compositions of at least one embodiment described herein.

FIGS. 6a and 6b are images under magnification illustrating the proliferation and morphology of NK-92 cells after thawing in cryopreservative compositions described herein.

### DETAILED DESCRIPTION

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the disclosure. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also included in the disclosure.

As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

As used in this specification and the appended claims, the term “or” is generally employed in its sense including “and/or” unless the content clearly dictates otherwise.

The term “about” or “approximately” means within an acceptable error range for the particular value as determined by one of ordinary skill in the art, which will depend in part on how the value is measured or determined, i.e., the limitations of the measurement system. For example, “about” can mean within 1 or more than 1 standard deviation, per the practice in the art. Alternatively, “about” can mean a range of up to 20%, up to 10%, up to 5%, or up to 1% of a given value or range. Alternatively, particularly with respect to biological systems or processes, the term can mean within an order of magnitude, preferably within 5-fold, and also preferably within 2-fold, of a value. Where particular values are described in the application and claims, unless otherwise stated the term “about” meaning within an acceptable error range for the particular value should be assumed.

As used herein, a “biological sample” refers to a sample including tissues, cells, organs, biological fluids, polypeptides, nucleic acids, or other biological substances. In some embodiments a biological sample can further include preservatives. In some embodiments, a sample can be obtained from a subject. In some embodiments a sample can be a diagnostic sample obtained from a subject. By way of non-limiting example, a sample can be a gamete, sperm, eggs, an embryo, a zygote, chondrocytes, red blood cells, blood, portions or fractions of blood, hepatic cells, fibroblasts, stem cells, cord blood cells, adult stem cells, induced pluripotent stem cells, autologous cells, autologous stem cells, bone marrow cells, hematopoietic cells, hematopoietic stem cells, somatic cells, germ line cells, differentiated cells, somatic stem cells, embryonic stem cells, serum, plasma, sputum, cerebrospinal fluid, urine, tears, alveolar isolates, pleural fluid, pericardial fluid, cyst fluid, tumor tissue, a biopsy, saliva, an aspirate, or combinations thereof. In some embodiments, a sample can be obtained by resection, biopsy, or egg retrieval.

As used herein, the phrase “cryoprotective agent” refers to a chemical or a chemical solution which facilitates the process of cryoprotection by reducing the injury of cells and tissues during freezing and thawing. The cryoprotective agent protects cells and tissues from damage associated with storage at sub-zero temperature and/or freezing, e.g., cell membrane damage due to ice crystal formation.

“Cryopreserved cells” or “cryopreserved tissues” are cells or tissues that have been preserved by cooling to a sub-zero temperature. Cryopreserved cells include eukaryotic and prokaryotic cells. Cryopreserved cells and tissues include, for example, animal, insect, bird, fish, reptile and plant cells or tissues.

The compositions of the present disclosure are thus cryoprotective, cryopreservative, or both.

As used herein, the terms “cell,” “cell line,” and “cell culture” may be used interchangeably. All of these terms also include their progeny, which are any and all subsequent generations. It is understood that all progeny may not be identical due to deliberate or inadvertent mutations. The “cells” can be prokaryotic or eukaryotic and encompass all species, e.g. mammals, fish, birds, reptiles, insects, fungi, bacterial and the like. In the context of expressing a heterologous nucleic acid sequence, “host cell” refers to a prokaryotic or eukaryotic cell, and it includes any transformable organism that is capable of replicating a vector or expressing a heterologous gene encoded by a vector. A host cell can, and has been, used as a recipient for vectors or viruses. A host cell may be “transfected” or “transformed,” which refers to a process by which exogenous nucleic acid, such as a recombinant protein-encoding sequence, is transferred or introduced into the host cell. A transformed cell includes the primary subject cell and its progeny.

A “carboxylated polyamino acid” includes any polyamino acid, such as polylysine, polyarginine, polyglutamine, etc., which has a repeating unit that has both amino and carboxyl groups, wherein at least a portion of the amino groups of the polyamino acid are partially blocked by being carboxylated (or acetylated) with carboxylic acid anhydride(s). This blockage is done by the carboxylation of the amino groups to the degrees greater than 50%, and ranging from about 50-99%, in embodiments about 52-90%, in other embodiments from about 55-75%, in still other embodiments about 57-67%, and in still other embodiments about 60%. About 50% of the amino groups would be blocked by being reacted with 52-53 mol % of anhydrous carboxylic acid on basis of molar amount of the amino groups in the polyamino acid. In a normal reaction condition, 90-95% of the amino groups would be blocked when reacted with 100 mol % anhydrous carboxylic acid.

Suitable carboxylic acid anhydrides useful in carboxylating polyamino acids include, without limitation, acetic anhydride, citric anhydride, succinic anhydride, glutaric anhydride, malic anhydride, fumaric anhydride and maleic anhydride. Among these, succinic anhydride and acetic anhydride are particularly useful.

In embodiments, the carboxylated polyamino acid may be derived from a polylysine. Polylysine is intended to include ε-poly-L-lysine or ε-poly-D-lysine or α-poly-L-lysine. The polylysine may include an average molecular weight of about 1,000-20,000 Daltons, and particularly between about 1,000-10,000 Daltons.

An “amphoteric” agent is one which can act either as an acid or base depending on the reaction in which it is involved. “Organic amphoteric agents” are organic molecules that contain both acidic (e.g., carboxyl) and basic (e.g., amino) functional groups. Thus, for example, an organic amphoteric agent includes an amino group (NH2) and a carboxylic group (COOH) bound to the same or different carbon atoms of a hydrocarbonic backbone. Further functional groups include, for example, an amino group (NH2), carboxylic group (COOH), carbonyl group (CO), hydroxy (OH) or mercapto group (SH) or aryls like phenyl. In embodiments, the organic amphoteric agent may be ectoine, hydroxyectoine, ectoine derivatives, hydroxyectoine derivatives, analogs, variants or combinations thereof. In some embodiments, the organic amphoteric agent is ectoine and/or hydroxyectoine.

As used herein, the term “polysaccharide” refers to chains of mono- or d-saccharide units bound together by glycosidic linkages. They range in structure from linear to highly branched. Some non-limiting examples include starch, glycogen, cellulose, chitin, chitosan, xylan, arabinoxylan, mannan, fucoidan, galactomannan, callose, laminarin, chrysolaminarin, amylopectin, dextran, dextrins, maltodextrins, hyaluronic acid, inulin, oligofructose, polydextrose, polysucrose, pullanan, etc. In embodiments, the cryopreservative compositions may include at least one polysaccharide selected from dextran, polysucrose and hyaluronic acid. In particular embodiments, the cryopreservative compositions may include dextran.

Dextrans are polysaccharides with molecular weights ≥1000 Dalton, which have a linear backbone of α-linked D-glucopyranosyl repeating units. Three classes of dextrans can be differentiated by their structural features:

Class 1 dextrans contain the α(1→6)-linked D-glucopyranosyl backbone modified with small side chains of D-glucose branches with α(1→2), α(1→3), and α(1→4)-linkage. The class 1 dextrans vary in their molecular weight, spatial arrangement, type and degree of branching, and length of branch chains, depending on the microbial producing strains and cultivation conditions. Isomaltose and isomaltotriose are oligosaccharides with the class 1 dextran backbone structure.

Class 2 dextrans (alternans) contain a backbone structure of alternating a(1→3) and α(1→6)-linked D-glucopyranosyl units with α(1→3)-linked branches.

Class 3 dextrans (mutans) have a backbone structure of consecutive a(1→3)-linked D-glucopyranosyl units with α(1→6)-linked branches. One and two-dimensional NMR spectroscopy techniques have been utilized for the structural analysis of dextrans.

In embodiments, the carboxylated polyamino acid and at least one of the organic amphoteric agent or the polysaccharide may be combined in a physiological solution, such as saline and dextrose, as well as culture media, e.g., Dulbecco-modified eagle culture medium (DMEM), for cryopreservation.

Cryopreservation or cryoprotection involves the storage of biological samples, including cells, tissues, and organs, at sub-zero temperatures at which biological activity effectively ceases. This allows storage of biological samples with minimal degradation of the sample and/or long-term storage of biological samples. Cryopreservation can be performed in a variety of different manners. For example, cryopreservation can be performed at a slower rate, referred to herein as “slow-rate cryopreservation,” wherein the decrease in temperature of the biological sample to sub-zero temperatures is typically performed over minutes, hours, days, etc. As another example, cryopreservation can be performed at a faster rate of cryopreservation, referred to herein as “fast-rate cryopreservation” which includes for example, vitrification and/or ultra-rapid freezing, wherein the decrease in temperature of the biological sample to sub-zero temperatures is typically performed in seconds or fractions of a second, such as milliseconds and at temperatures significantly lower than the temperatures associated with slow-rate cryopreservation. In embodiments, the slow-rate cryopreservation process may occur at temperatures ranging from 0° C. to −100° C. whereas fast-rate cryopreservation processes may occur at temperatures lowers than −100° C.

The cryopreservative compositions described herein may be adopted for use in any type of cryopreservation method, including for example slow-rate cryopreservation, or fast-rate cryopreservation including vitrification, and/or ultra-rapid freezing.

In embodiments, the cryopreservative compositions in accordance with the present disclosure may be suitable for use in slow-rate cryopreservation. In such embodiments, the cryopreservative composition may include from about 0.1% to about 20% v/v of a carboxylated polyamino acid, from about 0.1% to about 20% w/v of an organic amphoteric agent and optionally, from about 0.1% to about 20% w/v of a polysaccharide. In some embodiments, the organic amphoteric agent and the polysaccharide are present in the composition in equal or the same amounts, in particular embodiments, from about 3% to about 8% w/v. In some embodiments, the carboxylated polyamino acid is present in the composition at a ratio to the organic amphoteric agent ranging from about 1.1:1 to about 3:1, and particularly from about 1.5:1. In some embodiments, the carboxylated polyamino acid is present in the composition at a ratio to the organic amphoteric agent and the polysaccharide ranging from about 1.1:1:1 to about 3:1:1, and particularly from about 1.5:1:1.

In additional slow-rate cryopreservation embodiments, the cryopreservative composition may include from about 0.1% to about 20% v/v of a carboxylated polylysine, from about 0.1% to about 20% w/v of either ectoine and/or hydroxyectoine, and optionally, from about 0.1% to about 20% w/v of dextran.

In additional slow-rate cryopreservation embodiments, the cryopreservative compositions may include about 7.5% or less v/v of a carboxylated polyamino acid in combination with from about 5% or less w/v of an organic amphoteric agent and/or about 5% or less w/v of a polysaccharide.

In additional slow-rate cryopreservation embodiments, the cryopreservative compositions may include about 7.5% or less v/v of a carboxylated polylysine, about 5% or less w/v of ectoine and/or hydroxyectoine, and about 5% or less w/v of dextran.

In additional slow-rate cryopreservation embodiments, the cryopreservative composition may include from about 1% to about 10% v/v of a carboxylated polylysine, from about 1% to about 10% w/v of either ectoine and/or hydroxyectoine, and optionally, from about 1% to about 10% w/v of dextran. In such embodiments, the ectoine and/or hydroxyectoine and the dextran are present in the composition in equal or the same amounts, in particular embodiments, from about 3% to about 8% w/v. In some embodiments, the carboxylated polylysine is present in the composition at a ratio to the ectoine and/or hydroxyectoine and the dextran ranging from about 1.1:1:1 to about 3:1:1, and particularly from about 1.5:1:1.

In slow-rate cryopreservation embodiments, the cryopreservative compositions may further include a solvent. Any solvent suitable for cryopreservation may be incorporated into the compositions according to the present disclosure. Some non-limiting examples include Dulbecco's Modified Eagle Medium (DMEM), Eagle's Minimal Essential Medium (EMEM), X-VIVO, water, saline, dextrose, and combinations thereof. In embodiments, the compositions include DMEM. In other embodiments, the compositions include EMEM.

In additional slow-rate cryopreservation embodiments, the cryopreservative compositions may include additional cryoprotectant agents in amounts less than 5% w/v. Some non-limiting examples of additional cryoprotectant agents include trehalose, glycerol, polyethylene glycol, dimethyl sulfoxide, and the like. In other slow-rate cryopreservation embodiments, the cryopreservative compositions may be free of additional cryoprotectant agents, including but not limited to any one of trehalose, glycerol, polyethylene glycol, dimethyl sulfoxide, or any of these in combination.

In embodiments, methods of cryopreserving a biological sample include obtaining or collecting a biological sample, and contacting the biological sample with a cryopreservative composition suitable for slow-rate cryopreservation. In embodiments, the cryopreservative composition includes from about 0.1% to about 20% v/v of a carboxylated polyamino acid, from about 0.1% to about 20% w/v of an organic amphoteric agent and optionally, from about 0.1% to about 20% w/v of a polysaccharide. In embodiments, the carboxylated polyamino acid has greater than 50% of amino groups blocked with carboxyl groups. In embodiments, the composition includes carboxylated polylysine, ectoine and/or hydroxyectoine, and dextran.

In other embodiments, the cryopreservative compositions in accordance with the present disclosure may be suitable for use in fast-rate cryopreservation, such as vitrification and/or ultra-rapid freezing. In such embodiments, a cryopreservative composition may include from about 25% to about 55% v/v of a carboxylated polyamino acid, from about 25% to about 55% w/v of an organic amphoteric agent and optionally, from about 25% to about 55% w/v of a polysaccharide. In some embodiments, the organic amphoteric agent and the polysaccharide are present in the composition in equal or the same amounts, in particular embodiments, from about 25% to about 35% w/v. In some embodiments, the carboxylated polyamino acid is present in the composition at a ratio to the organic amphoteric agent ranging from about 1.1:1 to about 3:1, and particularly from about 1.5:1. In some embodiments, the carboxylated polyamino acid is present in the composition at a ratio to the organic amphoteric agent and the polysaccharide ranging from about 1.1:1:1 to about 3:1:1, and particularly from about 1.5:1:1.

In additional fast-rate cryopreservation embodiments, the cryopreservative composition may include from about 25% to about 55% v/v of a carboxylated polylysine, from about 25% to about 55% w/v of either ectoine and/or hydroxyectoine, and optionally, from about 25% to about 55% w/v of dextran. In such embodiments, the carboxylated polylysine may represent the largest concentration or majority compound of the composition.

In additional fast-rate cryopreservation embodiments, the cryopreservative composition may include from about 25% to about 55% v/v of a carboxylated polylysine, from about 25% to about 55% w/v of either ectoine and/or hydroxyectoine, and optionally, from about 25% to about 55% w/v of dextran. In such embodiments, the ectoine and/or hydroxyectoine and the dextran are present in the composition in equal or the same amounts, in particular embodiments, from about 25% to about 35% w/v. In some embodiments, the carboxylated polylysine is present in the composition at a ratio to the ectoine and/or hydroxyectoine and the dextran ranging from about 1.1:1:1 to about 3:1:1, and particularly from about 1.5:1:1.

In additional fast-rate cryopreservation embodiments, the cryopreservative compositions may further include a solvent. Any solvent suitable for cryopreservation may be incorporated into the compositions according to the present disclosure. Some non-limiting examples include Dulbecco's Modified Eagle Medium (DMEM), Eagle's Minimal Essential Medium (EMEM), X-VIVO, water, saline, dextrose, and combinations thereof. In embodiments, the compositions include DMEM. In embodiments, the compositions include EMEM.

In additional fast-rate cryopreservation embodiments, the cryopreservative compositions may include additional cryoprotectant agents in amounts less than 5% w/v. Some non-limiting examples of additional cryoprotectant agents include trehalose, glycerol, polyethylene glycol, dimethyl sulfoxide, and the like. In embodiments, the fast-rate cryopreservative compositions may be free of additional cryoprotectant agents, including but not limited to any one of trehalose, glycerol, polyethylene glycol, dimethyl sulfoxide, or combinations of these.

In embodiments, methods of cryopreserving a biological sample include obtaining or collecting a biological sample, and contacting the biological sample with a cryopreservative composition suitable for fast-rate cryopreservation. In embodiments, the cryopreservative composition includes from about 25% to about 55% v/v of a carboxylated polyamino acid, from about 25% to about 55% w/v of an organic amphoteric agent and optionally, from about 25% to about 55% w/v of a polysaccharide.

In embodiments, the carboxylated polyamino acid has greater than 50% of amino groups blocked, and particularly about 60% of the amino groups blocked. In embodiments, the composition includes carboxylated polylysine, ectoine and/or hydroxyectoine, and dextran.

In other embodiments, regardless of the rate of cryopreservation, the cryopreservative compositions may further include one or more pharmaceutically acceptable excipient or is diluted in a pharmaceutically acceptable excipient to obtain the desired ratio of agents in the cryoprotective composition. A pharmaceutically acceptable excipient, as used herein, includes any and all solvents, dispersion media, diluents, or other liquid vehicles, dispersion or suspension aids, surface active agents, isotonic agents, thickening or emulsifying agents, preservatives, solid binders, lubricants and the like, as suited to the particular formulation desired. Remington's The Science and Practice of Pharmacy, 21^{st} Edition, A. R. Gennaro, (Lippincott, Williams & Wilkins, Baltimore, Md., 2006; incorporated herein by reference) discloses various excipients used in formulating pharmaceutical compositions which excipients are useful in preparing the present cryoprotective compositions. Except insofar as any conventional excipient is incompatible with a substance or its derivatives, such as by producing any undesirable biological effect or otherwise interacting in a deleterious manner with any other component(s) of the pharmaceutical composition, its use is contemplated to be within the scope of this disclosure.

In some embodiments, the pharmaceutically acceptable excipient is at least 95%, 96%, 97%, 98%, 99%, or 100% pure. In some embodiments, the excipient is approved for use in humans and for veterinary use. In some embodiments, the excipient is approved for use in humans by the United States Food and Drug Administration. In some embodiments, the excipient is pharmaceutical grade. In some embodiments, the excipient meets the standards of the United States Pharmacopoeia (USP), the European Pharmacopoeia (EP), the British Pharmacopoeia, and/or the International Pharmacopoeia.

In another embodiment, a composition includes a viscosity enhancer. In certain embodiments, the viscosity enhancer is cellulose or a cellulose derivative. In certain embodiments, the viscosity enhancer is carboxymethylcellulose. In certain embodiments, the viscosity enhancer is methyl cellulose. In certain embodiments, the viscosity enhancer is one or more of ethyl cellulose, hydroxyethylcellulose, hydroxypropylcellulose, hydroxyethyl ethylcellulose, hydroxyethylcellulose, hydroxypropylcellulose, or hydroxybutyl cellulose. Other exemplary viscosity enhancers include synthetic polymers (e.g., acrylamides, acrylates). In certain embodiments, the viscosity enhancer is a wax or fatty alcohol (e.g., cetyl alcohol).

In certain embodiments, the compositions further include one or more therapeutic agents, hormones, growth factors, lipids, cytokines, oligonucleotides, polynucleotides, proteins, polypeptides, peptides, small molecules, chemotherapeutic agents and the like (e.g., polyphenols, fatty alcohols).

In embodiments, the cryoprotective and cryopreservative compositions embodied herein, allow for extreme cooling and thawing rates, overcome toxicity of high cryoprotectant agent (CPA) concentrations, allow for use of small volumes of biological media and are superior to traditional cryopreservative agents.

It will be appreciated that the thawing rate of cryopreserved cells or tissues, for example, will be influenced by a variety of factors. For example, the volume of the cryopreserved cells, handling time, ambient temperature, the temperature of incubation chambers used, heat transfer properties of the container housing the cells, the volume of the cryosolution added to the cryopreserved cells, and the like may influence thawing rate. It will also be appreciated that cells in a particular sample of cryopreserved cells may not all thaw at the same rate or within the same time period. Methods for thawing cryopreserved cells are well known in the art (See, e.g., Freshney R I, Culture of Animal Cells: A Manual of Basic Technique, 4^{th} Edition, 2000, Wiley-Liss, Inc., Chapter 19).

The cryopreserved cells to be thawed may be in a composition that occupies a volume of about 0.1 ml, 0.5 ml, 1 ml, about 2 ml, about 3 ml, about 4 ml, about 5 ml, about 10 ml, about 20 ml, about 30 ml, about 40 ml, about 50 ml, about 100 ml, about 200 ml, about 300 ml, about 400 ml, about 500 ml, about 1 L, or more. The cryopreserved cells may be in a composition that occupies a volume ranging from about 0.1 ml, 0.5 ml, 1 ml to about 10 ml, from about 10 ml to about 20 ml, from about 20 ml to about 30 ml, from about 30 ml to about 40 ml, from about 40 ml to about 50 ml, from about 50 ml to about 100 ml, from about 100 ml to about 200 ml, from about 200 ml to about 300 ml, from about 300 ml to about 400 ml, from about 400 ml to about 500 ml, or from about 500 ml to about 1 L. The composition including the cells may contain a tissue sample, e.g., a blood sample, a fat sample.

Typically, the step of thawing involves obtaining cryopreserved cells from storage at a temperature of less than about 0° C. (a subzero temperature) and allowing them to thaw to a temperature above 0° C. The step of thawing may involve obtaining the cryopreserved cells from storage at a temperature that ranges from about −205° C. to about −195° C. The step of thawing may involve obtaining the cryopreserved cells from storage at a temperature that ranges from about −80° C. to about −60° C. The step of thawing may involve progressively warming the cryopreserved cells by transferring the cells among incubators each having a warmer temperature range, e.g., to control the rate of thawing. For example, the step of thawing may involve first obtaining cryopreserved cells from storage at a first subzero temperature, e.g., that ranges from about −205° C. to about −195° C., and transferring the cryopreserved cells to a second, typically warmer, yet typically subzero, storage temperature, e.g., to a temperature that ranges from about −80° C. to about −60° C., prior to thawing. Any number of stages, for example, 2, 3, 4, 5, 6, or more stages, is envisioned to control the rate of thawing in this manner. The step of thawing may also involve progressively warming the cryopreserved cells by incubating the cells in a temperature controlled chamber, e.g., a water bath, heat block, oven, etc., and progressively warming the chamber, e.g., at a controlled rate, while the cryopreserved cells are present in the chamber.

The step of thawing may involve incubating the cryopreserved cells at a temperature that ranges from about 15° C. to about 30° C. The step of thawing may involve incubating the cryopreserved cells at a temperature that ranges from about 30° C. to about 45° C. Such incubation may be performed by incubating a container housing the cryopreserved cells in temperature controlled incubator, e.g., a temperature controlled water bath, a temperature controlled oven, etc. Other incubation methods will be apparent to the skilled artisan.

The step of thawing may be completed within about 30 seconds, about 1 minute, about 2 minutes, about 3 minutes, about 4 minutes, about 5 minutes, about 10 minutes, about 20 minutes, about 30 minutes, about 40 minutes, about 50 minutes, about 1 hour, or more. The step of thawing may be completed within a range of about 1 minute to about 5 minutes. The step of thawing may be completed within a range of about 5 minutes to about 10 minutes. The step of thawing may be completed within a range of about 10 minutes to about 30 minutes. The step of thawing may be completed within a range of about 30 minutes to about 60 minutes.

The step of thawing may involve warming the cryopreserved cells at a rate of about 1° C. per minute, about 2° C. per minute, about 3° C. per minute, about 4° C. per minute, about 5° C. per minute, about 10° C. per minute, about 20° C. per minute, about 30° C. per minute, about 40° C. per minute, about 50° C. per minute, about 60° C. per minute, about 70° C. per minute, about 80° C. per minute, about 90° C. per minute, about 100° C. per minute, about 200° C. per minute, or more. The step of thawing may involve warming the cryopreserved cells at a rate ranging from about 1° C. per minute to about 5° C. per minute. The step of thawing may involve warming the cryopreserved cells at a rate ranging from about 5° C. per minute to about 25° C. per minute. The step of thawing may involve warming the cryopreserved cells at a rate ranging from about 25° C. per minute to about 50° C. per minute. The step of thawing may involve warming the cryopreserved cells at a rate ranging from about 50° C. per minute to about 100° C. per minute. The step of thawing may involve warming the cryopreserved cells at a rate ranging from about 100° C. per minute to about 200° C. per minute. The rate of thawing may be continuous, e.g., constant rates until cells are completely thawed. The rate of thawing may also be discontinuous, e.g., the rate may be more rapid at some temperature ranges relative to the rate at other temperature ranges during thawing, for example, the rate may be more rapid in the range of about −200° C. to about 0° C. than in the range of about 0° C. to about 45° C. during the thawing.

Although not required or necessary, the cells may be washed at any stage during the cryopreservation process. In certain embodiments, the cells are washed after harvesting. In certain embodiments, the cells are washed after thawing. In certain embodiments, the cells are washed before transplantation. Such washing may minimize the presence of any cellular debris resulting from the cell collection process or the cryopreservation process. The washing of cells may be performed using any known methods in the art. For example, the cells may be washed with normal saline or another suitable wash solution. In certain embodiments, the volume of wash solution used is at least equal to the volume of cells being washed. The washing may involve suspending the cells in the wash solution and then centrifuging the cells to collect the washed cells. In other embodiments, the cells are centrifuged without adding any wash solution, and the cell pellet is resuspended in normal saline or another suitable solution for further use such as transplantation. The step of washing may be performed once or multiple times. In certain embodiments, the wash step may be repeated two, three, four, five, six, seven, or more times. Typically, the wash step is not performed more than two to three times. In certain embodiments, only a single wash is performed.

When freezing cells, the concentration of the cells which are to be cryopreserved may vary depending on a variety of factors, including, for example, the type of cell or tissue, the downstream application, etc. The concentration of certain cell types may be low, e.g., for oocytes the concentration may be as low as about 1-30 cells per ml, or lower. The concentration of cells may be about 10⁰ cells/ml, about 10¹ cells/ml, about 10² cells/ml, about 10³ cells/ml, about 10⁴ cells/ml, about 10⁵ cells/ml, about 10⁶ cells/ml, about 10⁷ cells/ml, about 10⁸ cells/ml, about 10⁹ cells/ml, or more. The concentration of cells may range from about 10⁰ cells/ml to about 10¹⁰ cells/ml, from about 10⁰ cells/ml to about 10¹ cells/ml, from about 10¹ cells/ml to about 10² cells/ml, from about 10² cells/ml to about 10³ cells/ml, from about 10³ cells/ml to about 10⁴ cells/ml, from about 10⁴ cells/ml to about 10⁵ cells/ml, from about 10⁵ cells/ml to about 10⁶ cells/ml, from about 10⁶ cells/ml to about 10⁷ cells/ml, from about 10⁷ cells/ml to about 10⁸ cells/ml, or from about 10⁸ cells/ml to about 10⁹ cells/ml, for example.

The methods and compositions disclosed herein may be used with any cryopreserved cells, typically eukaryotic cells. However, the methods and compositions disclosed herein are also envisioned for use with prokaryotic cells. The methods and compositions disclosed herein are also useful with plant cells, insect cells, etc.

Cells may be primary cells isolated from any tissue or organ (e.g., connective, nervous, muscle, fat or epithelial tissue). The cells may be mesenchymal, ectodermal, or endodermal. Cells may also be present in isolated connective, nervous, muscle, fat or epithelial tissue, e.g., a tissue explant, e.g., an adipose tissue obtained by liposuction. The connective tissue may be, for example, bone, ligament, blood, cartilage, tendon, or adipose tissue. The muscle tissue may be vascular smooth muscle, heart smooth muscle, or skeletal muscle, for example. The epithelial tissue may be of the blood vessels, ducts of submandibular glands, attached gingiva, dorsum of tongue, hard palate, esophagus, pancreas, adrenal glands, pituitary glands, prostate, liver, thyroid, stomach, small intestine, large intestine, rectum, anus, gallbladder, thyroid follicles, ependyma, lymph vessel, skin, sweat gland ducts, mesothelium of body cavities, ovaries, Fallopian tubes, uterus, endometrium, cervix (endocervix), cervix (ectocervix), vagina, labia majora, tubuli recti, rete testis, ductuli efferentes, epididymis, vas deferens, ejaculatory duct, bulbourethral glands, seminal vesicle, oropharynx, larynx, vocal cords, trachea, respiratory bronchioles, cornea, nose, proximal convoluted tubule of kidney, ascending thin limb of kidney, distal convoluted tubule of kidney, collecting duct of kidney, renal pelvis, ureter, urinary bladder, prostatic urethra, membranous urethra, penile urethra, or external urethral orifice, for example.

The cells may be any mammalian cells. The cells may be any human cells. The cells include: lymphocytes, B cells, T cells, cytotoxic T cells, natural killer T cells, regulatory T cells, T helper cells, myeloid cells, granulocytes, basophil granulocytes, eosinophil granulocytes, neutrophil granulocytes, hypersegmented neutrophils, monocytes, macrophages, reticulocytes, platelets, mast cells, thrombocytes, megakaryocytes, dendritic cells, thyroid cells, thyroid epithelial cells, parafollicular cells, parathyroid cells, parathyroid chief cells, oxyphil cells, adrenal cells, chromaffin cells, pineal cells, pinealocytes, glial cells, glioblasts, astrocytes, oligodendrocytes, microglial cells, magnocellular neurosecretory cells, stellate cells, boettcher cells; pituitary cells, gonadotropes, corticotropes, thyrotropes, somatotrope, lactotrophs, pneumocyte, type I pneumocytes, type II pneumocytes, Clara cells; goblet cells, alveolar macrophages, myocardiocytes, pericytes, gastric cells, gastric chief cells, parietal cells, goblet cells, paneth cells, G cells, D cells, ECL cells, I cells, K cells, S cells, enteroendocrine cells, enterochromaffin cells, APUD cell, liver cells, hepatocytes, Kupffer cells, bone cells, osteoblasts, osteocytes, osteoclast, odontoblasts, cementoblasts, ameloblasts, cartilage cells, chondroblasts, chondrocytes, skin cells, hair cells, trichocytes, keratinocytes, melanocytes, nevus cells, muscle cells, myocytes, myoblasts, myotubes, adipocyte, fibroblasts, tendon cells, podocytes, juxtaglomerular cells, intraglomerular mesangial cells, extraglomerular mesangial cells, kidney cells, kidney cells, macula densa cells, spermatozoa, sertoli cells, leydig cells, oocytes, and mixtures thereof.

The cells may also be isolated from a diseased tissue, e.g., a cancer. Accordingly, the cells may be cancer cells. For example, the cells may be isolated or derived from any of the following types of cancers: breast cancer; biliary tract cancer; bladder cancer; brain cancer including glioblastomas and medulloblastomas; cervical cancer; choriocarcinoma; colon cancer; endometrial cancer; esophageal cancer; gastric cancer; hematological neoplasms including acute lymphocytic and myelogenous leukemia; T-cell acute lymphoblastic leukemia/lymphoma; hairy cell leukemia; chronic myelogenous leukemia, multiple myeloma; AIDS-associated leukemias and adult T-cell leukemia/lymphoma; intraepithelial neoplasms including Bowen's disease and Paget's disease; liver cancer; lung cancer; lymphomas including Hodgkin's disease and lymphocytic lymphomas; neuroblastomas; oral cancer including squamous cell carcinoma; ovarian cancer including those arising from epithelial cells, stromal cells, germ cells and mesenchymal cells; pancreatic cancer; prostate cancer; rectal cancer; sarcomas including leiomyosarcoma, rhabdomyosarcoma, liposarcoma, fibrosarcoma, and osteosarcoma; skin cancer including melanoma, Merkel cell carcinoma, Kaposi's sarcoma, basal cell carcinoma, and squamous cell cancer; testicular cancer including germinal tumors such as seminoma, non-seminoma (teratomas, choriocarcinomas), stromal tumors, and germ cell tumors; thyroid cancer including thyroid adenocarcinoma and medullar carcinoma; and renal cancer including adenocarcinoma and Wilms' tumor.

The cells may include cord-blood cells, stem cells, umbilical cells, amniotic cells, embryonic stem cells, adult stem cells, cancer stem cells, progenitor cells, autologous cells, isograft cells, allograft cells, xenograft cells, bone marrow cells or genetically engineered cells. The cells may be induced progenitor cells. The cells may be cells isolated from a subject, e.g., a donor subject, which have been transfected with a stem cell associated gene to induce pluripotency in the cells. The cells may be cells which have been isolated from a subject, transfected with a stem cell associated gene to induce pluripotency, and differentiated along a predetermined cell lineage. The cells may be cells including a vector expressing a desired product. These or any other types of cells may be used for transplantation or administration to a subject in need of therapy.

Cells lines of any of the cells disclosed herein may also be used with the methods disclosed herein.

The present disclosure also provides methods of transplanting cells in a subject. The cells or tissues may be autologous, haplotyped matched, transformed cells, allogeneic, xenogeneic, cells expressing a desired product or combinations thereof. The methods typically involve thawing cryopreserved cells which have been frozen in the cryoprotective compositions embodied herein and transplanting the thawed cells in the subject. The method may involve obtaining the cells from a donor that is not the transplant recipient, e.g., for use as an allograft, isograft, or xenograft. The methods may involve obtaining the cells from the subject who is the transplant recipient for use as an autograft. The methods may involve expanding the cells in vitro prior to transplanting. The cells may be cryopreserved while situated in a tissue. The cells may be isolated from a tissue and then cryopreserved. The cells may be cryopreserved while situated in a tissue and isolated from the tissue following thawing.

The resulting cryocell composition may be further processed before implantation into a subject. For example, the cells may be washed, purified, extracted, expanded, or otherwise treated before implantation into a subject.

The cryopreserved cells may be thawed and seeded in a scaffold material that allows for attachment of cells and facilitates production of an engineered tissue. In one embodiment, the scaffold is formed of synthetic or natural polymers, although other materials such as hydroxyapatite, silicone, and other inorganic materials can be used. The scaffold may be biodegradable or non-degradable. Representative synthetic non-biodegradable polymers include ethylene vinyl acetate and polymethacrylate. Representative biodegradable polymers include polyhydroxyacids such as polylactic acid and polyglycolic acid, polyanhydrides, polyorthoesters, and copolymers thereof. Natural polymers include collagen, hyaluronic acid, and albumin. Hydrogels are also suitable. Other hydrogel materials include calcium alginate and certain other polymers that can form ionic hydrogels that are malleable and can be used to encapsulate cells.

The scaffolds may be used to produce new tissue, such as vascular tissue, bone, cartilage, fat, muscle, tendons, and ligaments. The scaffold is typically seeded with the cells; the cells are cultured; and then the scaffold implanted. Applications include the repair and/or replacement of organs or tissues, such as blood vessels, cartilage, joint linings, tendons, or ligaments, or the creation of tissue for use as “bulking agents”, which are typically used to block openings or lumens, or to shift adjacent tissue, as in treatment of reflux.

Besides adipocytes, fat tissue has been found to be a source of stem cells (Gimble et al., “Adipose-Derived Stem Cells for Regenerative Medicine” Circulation Research 100:1249-1260, 2007; incorporated herein by reference). Therefore, compositions embodied herein, are useful in stabilizing and preventing damage to stem cells or other cells derived from fat tissue following cryopreservation. In certain embodiments, the compositions are useful in the transplantation of adult stem cells. In certain embodiments, the compositions are useful in the transplantation of fibroblasts.

The cryopreserved cells may be used for any appropriate downstream application, e.g., research, tissue culture, drug discovery, biologics production, etc. The cells may be used for microscopy, e.g., in combination with immunostaining, in situ hybridization, etc. The cells may be used for functional studies such as gene knockdown or overexpression studies. The cells may be used to study various molecular pathways, e.g., cell cycle, cell signaling, gene regulatory, etc. The cells may be separated by flow cytometry. The cells may be used to create cell lines. The cells may be used for fractionation studies, e.g., to 3.0 purify proteins or molecules from different cellular compartments. The cells may be used for studying different disease pathways, e.g., cancer. The cells may be transplanted into an animal model, e.g., to study tumor growth. The cells may be used for gene, e.g., mRNA or miRNA, profiling studies. The karyotype or genotype of the cells may be evaluated. The cells may be used for isolation of various biomolecules, e.g., antibodies, proteins, RNA, DNA, ligands, etc.

The cells may be used for automated microscopy for high-content screening, e.g., for lead identification and compound characterization. The cells may be used for the evaluation, e.g., by screening, e.g., high-throughput screening, of compounds, e.g., small-molecules, siRNAs, peptides, etc., for a desired activity, e.g., inhibition of cell growth, modulation of a particular biochemical pathway, modulation of the expression of a certain gene, binding to a target, etc.

The cells may be used in a biopharmaceutical context for the production and isolation of therapeutic molecules, e.g., antibodies, enzymes, etc. The cells may be shipped, e.g., on dry ice in the presence of a polymer, e.g., a polyether, to a customer, collaborator, etc. The cells may be evaluated for contamination, e.g., bacterial, mycoplasmal, viral, etc. The uses disclosed herein are not intended to be limiting and a variety of other uses for the cryopreserved cells are also envisioned and will be apparent to the skilled artisan.

In other embodiments, the cryopreservative compositions may be used for the cryopreservation of organs, or for the transport of organs under temperatures suitable for the maintenance of viability of the organ for use in organ transplants and organ donor programs. For the cryopreservation of organs, the organ may be perfused with the cryoprotective compositions and frozen under conditions which preserve the viability of the organ. Procedures for thawing the organs for transplantation are known to those of skill in the art.

The present disclosure also provides kits that include one or more containers filled with agents suitable for formulating the cryopreservative compositions described herein, the containers being enclosed in a single package. For example, the kit may include a first container with a carboxylated-polyamino acid therein, a second container with at least one organic amphoteric agent therein, and a third container with a polysaccharide therein. The agents may be in a form ready for mixing or can be premixed, or in concentrated form whereby the user dilutes the concentrated form to predetermined specifications. In some embodiments, the carboxylated-polyamino acid is carboxylated polylysine. In some embodiments, the organic amphoteric agent is ectoine and/or hydroxyectoine. In some embodiments, the organic amphoteric agent includes ectoine, hydroxyectoine, ectoine derivatives, hydroxyectoine derivatives, analogs, variants or combinations thereof. In some embodiments, the polysaccharide is dextran. The kit may also contain one or more diluents, for example, pharmaceutically acceptable excipients, distilled water, saline, biological media, etc.

The kit may also contain instructions for diluting or mixing the agents. The instructions may also include information regarding the contacting of the biological sample with the composition for freezing. Instructions may also include thawing the cryopreserved cells. Such instructions may also include information relating to administration of cells, tissues etc. that had been cryopreserved and thawed.

The kit can also include a notice typically in a form prescribed by a government agency regulating the manufacture, use, or sale of medical devices and/or pharmaceuticals, whereby the notice is reflective of approval by the agency of the compositions, for human or veterinary administration in tissue transplantation.

The kit may include a device or receptacle for preparation of the composition. The device may be, e.g., a measuring or mixing device.

The kit may also optionally include a device for administering the composition of the present disclosure. Exemplary devices include specialized syringes, needles, and catheters that are compatible with a variety of laryngoscope designs.

### EXAMPLE 1

A cryopreservative composition suitable for a slow-rate cryopreservation process to a temperature of −80° C. includes 7.5% v/v carboxylated-polylysine and 5% w/v dextran-40 mixed in Dulbecco's Modified Eagle Medium (DMEM). Approximately sixty (60)% of the amino groups of the polylysine were carboxylated by reaction with succinic anhydride. The carboxylated polylysine, in water as its solvent, is mixed with dextran-40 in a 1:3 ratio in DMEM.

### EXAMPLE 2

A cryopreservative composition suitable for a slow-rate cryopreservation process to a temperature of −80° C. includes 7.5% v/v carboxylated-polylysine and 5% w/v ectoine mixed in DMEM. Approximately sixty (60) % of the amino groups of the polylysine were carboxylated by reaction with succinic anhydride. The carboxylated polylysine, in water as its solvent, is mixed with ectoine in a 1:3 ratio in DMEM.

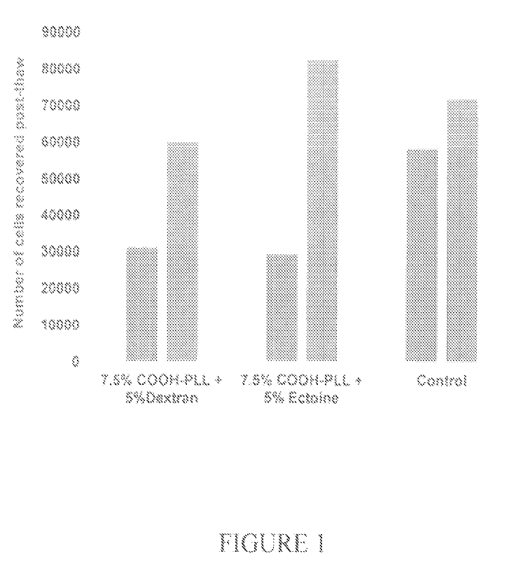

The effectiveness of the cryopreservative compositions of Examples 1 and 2 were analyzed and compared to a standard cryopreservation media containing EMEM, FBS and 10% dimethyl sulfoxide (DMSO). The results are summarized in FIGS. 1-3.

As illustrated in FIG. 1, cell recovery of fetal lung fibroblasts TIG-3-20 was analyzed via Trypan Blue assay both post-thaw (left bar) and after 1 passage (right bar). The fibroblasts were placed in one of the control medium, the cryopreservative composition of Example 1, and the cryopreservative composition of Example 2.

As depicted in FIG. 1, carboxylated-polylysine combined with a low concentration of ectoine (5%) is efficient in cryopreserving various cell types, including fibroblasts, and improves cell recovery as compared to standard cryopreservation media containing DMSO.

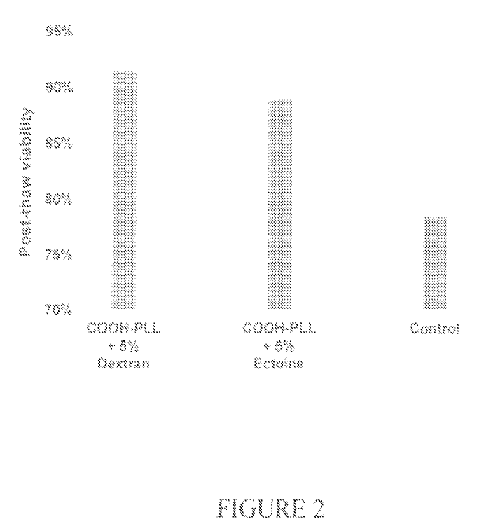

As illustrated in FIG. 2, cell viability via Trypan Blue assay for fetal lung fibroblasts TIG-3-20 was also analyzed after thawing for three days in one of the control medium, the cryopreservative composition of Example 1, and the cryopreservative composition of Example 2.

As depicted in FIG. 2, carboxylated-polylysine combined with a low concentration of ectoine (5%) or carboxylated-polylysine combined with a low concentration of dextran (5%) is efficient in cryopreserving various cell types, including fibroblasts, and improving post-thaw viability of the cells, as compared to standard cryopreservation media containing DMSO.

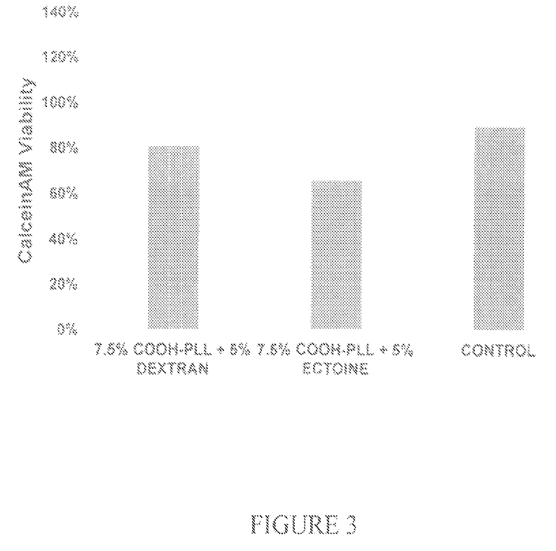

As illustrated in FIG. 3, cell viability via CalceinAM assay for dendritic cells was analyzed after thawing in one of the control medium, the cryopreservative composition of Example 1, and the cryopreservative composition of Example 2.

Viabilities were measured after the cells were thawed.

### EXAMPLE 3

A cryopreservative composition suitable for a slow-rate cryopreservation process to a temperature of −80° C. includes 7.5% v/v carboxylated-polylysine, 5% w/v ectoine, and 5% w/v dextran-40 mixed in DMEM. Approximately sixty (60)% of the amino groups of the polylysine were carboxylated by reaction with succinic anhydride. The carboxylated polylysine, in water as its solvent, is mixed with dextran-40 and ectoine in a 1:3 ratio in DMEM.

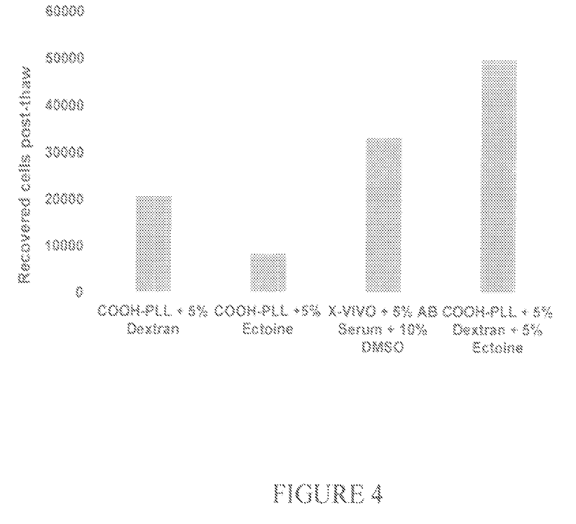

As illustrated in FIG. 4, cell recovery of Natural Killer 92 (NK-92) cells was analyzed via Trypan Blue assay post-thaw. The NK-92 cells showed improved post-thaw recovery in the cryopreservative composition of Example 3, as compared to the cryopreservative compositions of Examples 1 and 2, as well as the control (5% AB Serum, 10% DMSO in X-VIVO^{Tm}).

As depicted in FIG. 4, carboxylated-polylysine combined with both a low concentration of ectoine (less than 5%) and a low concentration of dextran (less than 5%) is efficient in cryopreserving various cell types, including NK cells, and improving cell recovery, as compared to standard cryopreservation media containing DMSO, carboxylated-polylysine combined only with a low concentration of ectoine (less than 5%) and carboxylated-polylysine combined only with a low concentration of dextran (less than 5%).

### EXAMPLE 4

A cryopreservative composition suitable for a cryopreservation process includes 7.5% v/v carboxylated-polylysine, 20% w/v ectoine, and 20% w/v dextran-40 mixed in DMEM. The carboxylated polylysine, in water as its solvent, is mixed with dextran-40 and ectoine in a 1:3 ratio in DMEM.

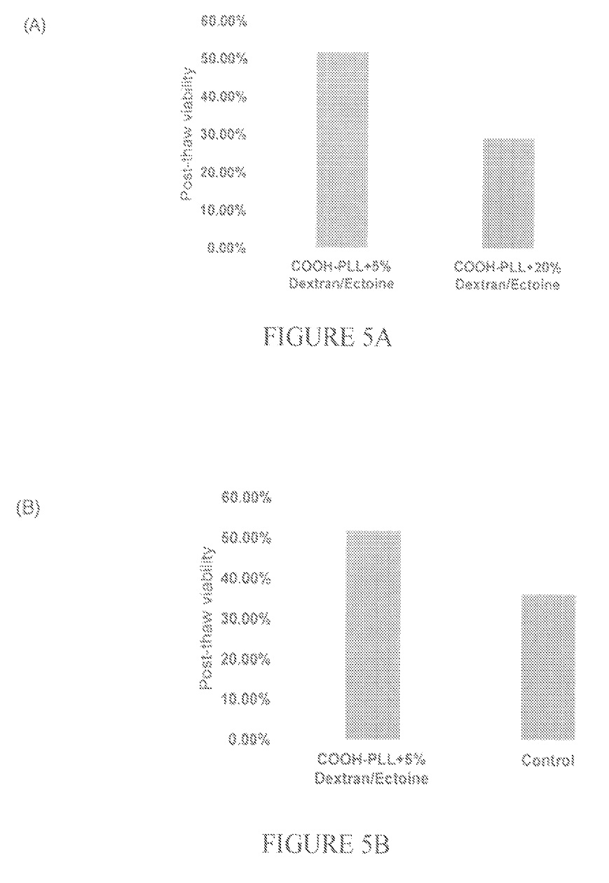

As illustrated in FIGS. 5A and 5B, cell viability of NK-92 cells was also analyzed post thaw in one of the control medium, the cryopreservative composition, of Example 3 and the cryopreservative composition of Example 4. The NK-92 cells showed improved post-thaw recovery in the cryopreservative composition of Example 3, as compared to the cryopreservative composition of Example 4, as well as the 10% DMSO control of Example 3.

To obtain the data for FIGS. 5A and 5B, the NK-92 cells were proliferated sufficiently to reach confluence and then slowly cryopreserved by freezing the same concentration of NK-92 cells in each of the cryopreservative composition of Example 3, the cryopreservative composition of Example 4, and the control media for 24 hours at −80° C. followed by placement in Liquid Nitrogen (LN2) for up to 7 days.

As depicted in FIGS. 5A and 5B, carboxylated-polylysine combined with both a low concentration of ectoine (less than 5%) and a low concentration of dextran (less than 5%) is efficient in cryopreserving various cell types, including NK cells, and improving cell viability, as compared to standard cryopreservation media containing DMSO, as well as carboxylated-polylysine combined with both a high concentration of ectoine (20%) and a high concentration of dextran (20%).

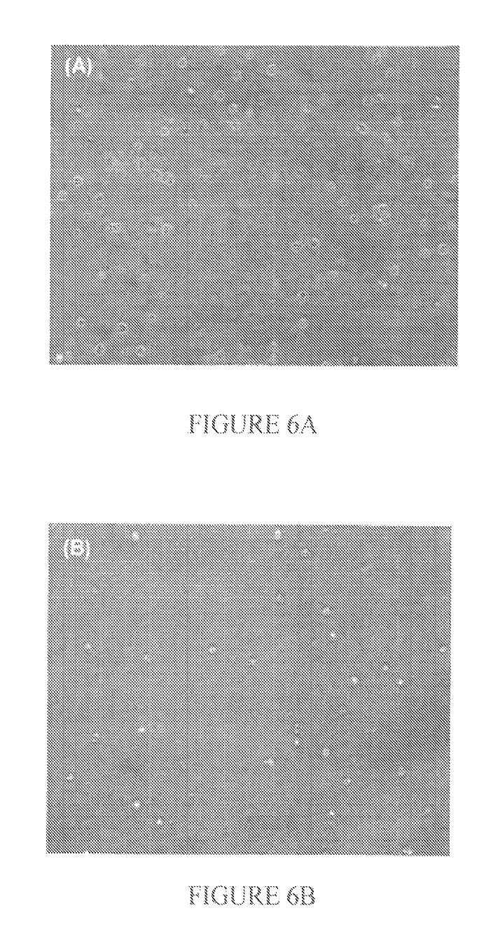

As further shown in FIGS. 6A and 6B, NK-92 cells thawed after being cryopreserved in the cryopreservative composition of Example 3 were higher in number and healthier in morphology than the NK-92 cells cryopreserved slowly in the cryopreservative composition of Example 4, which showed weaker expansion 24 hours after being thawed.

It is envisioned that the cryopreservative composition of Example 4 is more suitable for a fast cryopreservation process such as vitrification, as compared to the cryopreservative compositions of Examples 1-3, which are well-suited for a slow cryopreservation process.

### EXAMPLE 5

A cryopreservative composition suitable for fast-rate cryopreservation, including vitrification and/or ultra-rapid freezing, to a temperature of less than −100° C. includes 52.5% v/v carboxylated-polylysine, 35% w/v ectoine, and 35% w/v dextran-40 mixed in DMEM. Approximately sixty (60)% of the amino groups of the polylysine are carboxylated by reaction with succinic anhydride. The carboxylated polylysine, in water as its solvent, is mixed with dextran-40 and ectoine to their final concentrations by adding DMEM.

### EXAMPLE 6

A cryopreservative composition suitable for fast-rate cryopreservation, including vitrification and/or ultra-rapid freezing, to a temperature of less than −100° C. includes 37.5% v/v carboxylated-polylysine, 25% w/v ectoine, and 25% w/v dextran-40 mixed in DMEM. Approximately sixty (60)% of the amino groups of the polylysine are carboxylated by reaction with succinic anhydride. The carboxylated polylysine, in water as its solvent, is mixed with dextran-40 and ectoine to their final concentrations by adding DMEM.

While various embodiments of the present disclosure have been described above, it should be understood that they have been presented by way of example only, and not limitation. Numerous changes to the disclosed embodiments can be made in accordance with the disclosure herein without departing from the spirit or scope of the disclosure.

Thus, the breadth and scope of the present disclosure should not be limited by any of the above described embodiments.

What is claimed is:

1. A cryopreservative composition comprising a carboxylated-polyamino acid, an organic amphoteric agent, and optionally a polysaccharide.

2. The composition according to claim 1, wherein the carboxylated-polyamino acid is carboxylated-polylysine.

3. The composition according to claim 2, wherein greater than 50% of amino groups on the carboxylated-polylysine are blocked.

4. The composition according to claim 2, wherein about 50% to about 65% of amino groups on the carboxylated-polylysine are blocked.

5. The composition according to claim 1, wherein the carboxylated-polyamino acid is present in an amount ranging from 0.1% to about 20% v/v of the cryopreservative composition.

6. The composition according to claim 1, wherein the carboxylated-polyamino acid is present in an amount ranging from 1.0% to about 10% v/v of the cryopreservative composition.

7. The composition according to claim 1, wherein the organic amphoteric agent is selected from ectoine, hydroxyectoine, and combinations thereof.

8. The composition according to claim 1, wherein organic amphoteric agent is present in an amount ranging from about 0.1% to about 20% w/v of the cryopreservative composition.

9. The composition according to claim 1, wherein organic amphoteric agent is present in an amount ranging from about 1.0% to about 10% w/v of the cryopreservative composition.

10. The composition according to claim 1, wherein the polysaccharide is dextran.

11. The composition according to claim 1, wherein the polysaccharide is present in an amount ranging from about 0.1% to about 20% w/v of the cryopreservative composition.

12. The composition according to claim 1, wherein the polysaccharide is present in an amount ranging from about 1.0% to about 10% w/v of the cryopreservative composition.

13. The composition according to claim 1, wherein the polysaccharide and the organic amphoteric agent are present in the same amount ranging from about 3.0% w/v to about 8% w/v of the cryopreservative composition.

14. The composition according to claim 1, wherein the cryopreservative composition comprises about 7.5% or less v/v of a carboxylated polyamino acid, from about 5% or less w/v of an organic amphoteric agent, and about 5% or less w/v of a polysaccharide.

15. The composition according to claim 1, wherein the carboxylated polyamino acid comprises about 7.5% or less v/v of a carboxylated polylysine, the organic amphoteric agent comprises about 5% or less w/v of ectoine and/or hydroxyectoine, and the polysaccharide comprises about 5% or less w/v of dextran.

16. The composition according to claim 1, wherein the carboxylated-polyamino acid is present in a ratio to the organic amphoteric agent ranging from about 1.1:1 to about 3:1.

17. The composition according to claim 1, wherein the carboxylated-polyamino acid is present in a ratio to the organic amphoteric agent of about 1.3:1 to about 1.7:1.

18. The composition according to claim 2, wherein the organic amphoteric agent is ectoine and the polysaccharide is dextran.

19. The composition according to claim 1, further comprising a solvent selected from the group consisting of DMEM, EMEM, X-VIVO, saline, water, and combinations thereof.

20. A method of cryopreserving a biological sample comprising: obtaining a biological sample; and, contacting the biological sample with a cryopreservative composition, wherein the cryopreservative composition comprises from about 1% to about 10% v/v of a carboxylated-polyamino acid, from about 1% to about 10% w/v of an organic amphoteric agent, and from about 0% to about 10% w/v of a polysaccharide.

21. The method of claim 20, wherein the cryopreservative composition comprises from about 1% to about 10% v/v of a carboxylated-polylysine having greater than 50% of amino groups blocked, from about 1% to about 10% w/v ectoine and from about 1% to about 10% w/v of dextran.

22. The method according to claim 20, wherein the carboxylated-polylysine is present in a ratio to the organic amphoteric agent and the polysaccharide ranging from about 1.1:1:1 to about 3:1:1.

23. The method according to claim 20, wherein the carboxylated-polylysine is present in a ratio to the organic amphoteric agent and the polysaccharide is from about 1.5:1:1.

24-26. (canceled)

27. A cryopreservative composition for fast-rate cryopreservation comprising about 20% to about 55% v/v carboxylated-polylysine, about 20% to about 55% ectoine or hydroxyectoine, and optionally about 20% to about 55% a polysaccharide.

28. The composition according to claim 27, wherein greater than 50% of amino groups on the carboxylated-polylysine are blocked.

29. The composition according to claim 27, wherein about 60% of amino groups on the carboxylated-polylysine are blocked.

30. The composition according to claim 27, wherein the carboxylated-polylysine is present in an amount ranging from about 22.5% to about 52.5% v/v of the cryopreservative composition.

31. The composition according to claim 27, wherein the ectoine or hydroxyectoine is present in an amount ranging from about 25% to about 35% w/v of the cryopreservative composition.

32. The composition according to claim 27, wherein the polysaccharide is dextran.

33. The composition according to claim 27, wherein the dextran is present in an amount ranging from about 25% to about 35% w/v of the cryopreservative composition.

34. The composition according to claim 27, wherein the polysaccharide and the organic amphoteric agent are present in the same amount ranging from about 25.0% to about 35% w/v of the cryopreservative composition.

35. The composition according to claim 27, wherein the carboxylated-polylysine is present in a ratio to the ectoine and/or hydroxyectoine ranging from about 1.1:1 to about 3:1.

36. The composition according to claim 27, wherein the carboxylated-polylysine is present in a ratio to the ectoine and/or hydroxyectoine of about 1.3:1 to about 1.7:1.

37-42. (canceled)
